(19) United States
(12) Patent Application Publication
(10) Pub. No.: US 2015/0342328 A1
(43) Pub. Date: Dec. 3, 2015

(54) Ring Tool Holder

(71) Applicant: Daniel Ernest Seger, Hanover, MD (US)

(72) Inventor: Daniel Ernest Seger, Hanover, MD (US)

(21) Appl. No.: 14/289,674

(22) Filed: May 29, 2014

(51) Int. Cl. A45F 5/00; B43K 23/012

(52) U.S. Cl. CPC A45F 5/004; B43K 23/012

(57) ABSTRACT

The present invention relates, in general, to a tool holing device consisting of a retraction mechanism capable of temporarily attaching to a tool to hold it conveniently accessible when needed, and out-of-the-way when not needed. This device is also capable of docking such that the user can control where he or she would like a tool to be held.

### BACKGROUND OF THE INVENTION

Writing, drawing, painting, and crafting tools are often set down to allow the user to accomplish alternative tasks with his or her fingers. These tools are invariably needed again, usually in a short time. When needed, valuable time is spent locating the tool, compromising workflow, and occasionally even resulting in the need to purchase a replacement tool.

This issue is apparent to electronics manufacturers, who often engineer products with a loop or magnetic component to hold such a tool. However, even these solutions are quite limited, allowing the tool to slip out at times when the user is not paying attention resulting in an increased risk of losing the tool all together. Alternatively, if the tool is securely fastened, then the user will spend unnecessary time fumbling to retrieve the tool and likely not even use the holder during times of use.

Whether using a stylus, pen, pencil, paint-brush, or crafting tool it is valuable to the user, both in preserving workflow and in saving time, to have that tool at his or her fingertips when it is needed, and out of the way when it is not.

### SUMMARY OF THE INVENTION

The present invention is a tool holder, which can be mounted such that the tool it holds is ideally accessibly allowing for optimum hassle-free placement of a tool. To ensure the tool returns to its optimum placement, without any effort on the part of the user, the present invention employs a retraction mechanism. This invention features innovations in object orientation as well as several interchangeable pieces and interchange mechanisms, allowing unprecedented flexibility in its configurations and thus increased utility to the end-user.

The present invention and the various exemplary embodiments of it include mechanisms of alignment to ensure that a tool returns to precisely the exact placement and orientation each time it is released by the user. This is an essential feature for the placement of the device to be called an ‘ideally accessible’ place, such as on the user's index finger or thumb. This also becomes quite useful when utilizing the retraction mechanism for any tool that is only useable at a certain orientation, as the present invention can maintain the orientation in which the tool is most useful to the user.

The interchangeability within the present invention, among other things, allows a user to quickly change what tool is ideally accessible from one tool to another, such as from a pen to a stylus without needing to have two separate devices. This adds value and convenience for the user.

Additional aspects, objectives, features, and advantages of the present invention will become apparent from the following description of the preferred embodiments with reference to the attached drawings.

### DESCRIPTION OF PRIOR ART

The utility of a retractable tool-holding device is apparent. The prior art is crowded with retractable article holders, and the basic features of the present invention are discoverable therein. However, the prior art lacks any device that combines the features that give the present invention its increased utility and value. The two main innovations of the present invention that are lacking in the prior art are its interchangeability and its feature of holding the tool at a fixed orientation while in a resting or non-use position. Both of these features add value and utility separately and are combined herein with several other features of the already useful retracting tool holders present in the prior art.

### BRIEF DESCRIPTION OF THE DRAWINGS

FIG. 1 is a perspective view of a fully assembled preferred embodiment of the tool holder

FIG. 2 is an alternate perspective of a fully assembled preferred embodiment of the tool holder

FIG. 3 is a perspective of a clip interchange mechanism

FIG. 4 is an exploded view of the clip interchange mechanism of FIG. 3

FIG. 5 is an exploded view of the opposite end of the clip interchange mechanism of FIG. 3

FIG. 6 is a perspective of a complete sliding interchange mechanism

FIG. 7 is an alternate perspective of the complete sliding interchange mechanism from FIG. 6

FIG. 8 is a perspective view of a separated preferred embodiment showing the sliding mechanism incorporated therein

FIG. 9 is a view of an alternative preferred embodiment of the sliding interchange mechanism incorporated into a flexible band

FIG. 10 is an alternate perspective of the separated preferred embodiment of FIG. 8

FIG. 11 is another alternate perspective of the separated preferred embodiment of FIG. 8

FIG. 12 is another alternate perspective of the separated preferred embodiment of FIG. 8

### DETAILED DESCRIPTION

The detailed description set forth below in connection with the attached drawings is intended as a description of preferred embodiments and is not intended to represent the only forms in which the preferred embodiments may be constructed and/or utilized.

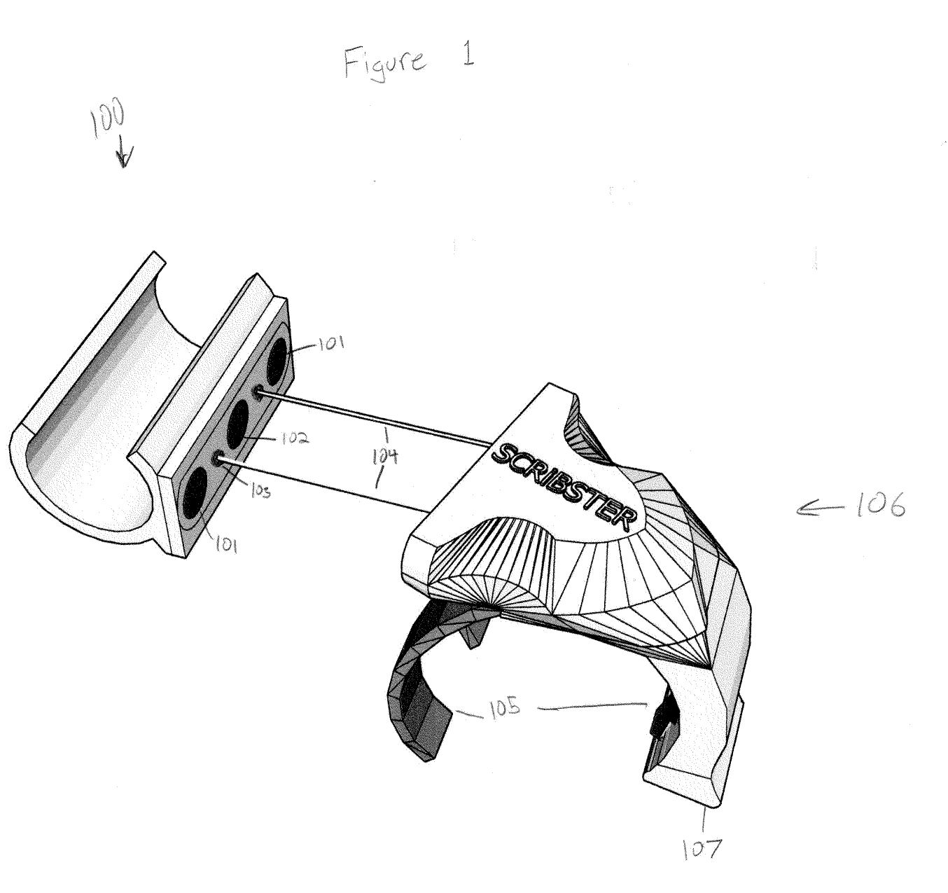

In examining the drawings, FIG. 1 illustrates a preferred embodiment for the assembled tool holder, with the docked interchangeable tool clip 100 extended away from the housing for the retraction mechanism 106/ This positioning is hereafter referred to as the ‘use position’. In the preferred embodiment illustrated in FIG. 1, the retraction mechanism is two elastic strings 104, which are exposed when a tool is held in the use position and are contained within the housing 106 when the clip 100 is in the resting or non-use position (not shown). In this preferred embodiment, the housing 106 is shown fully docked to an adjustable ring 105 which is split and widened in the front of the device to add stability. This preferred embodiment is designed to mount to the index finger of the right hand of the user so the lip 107 on the bottom of the ring can be utilized easily by the middle finger to provide counter-rotational force to ensure the device remains ideally located.

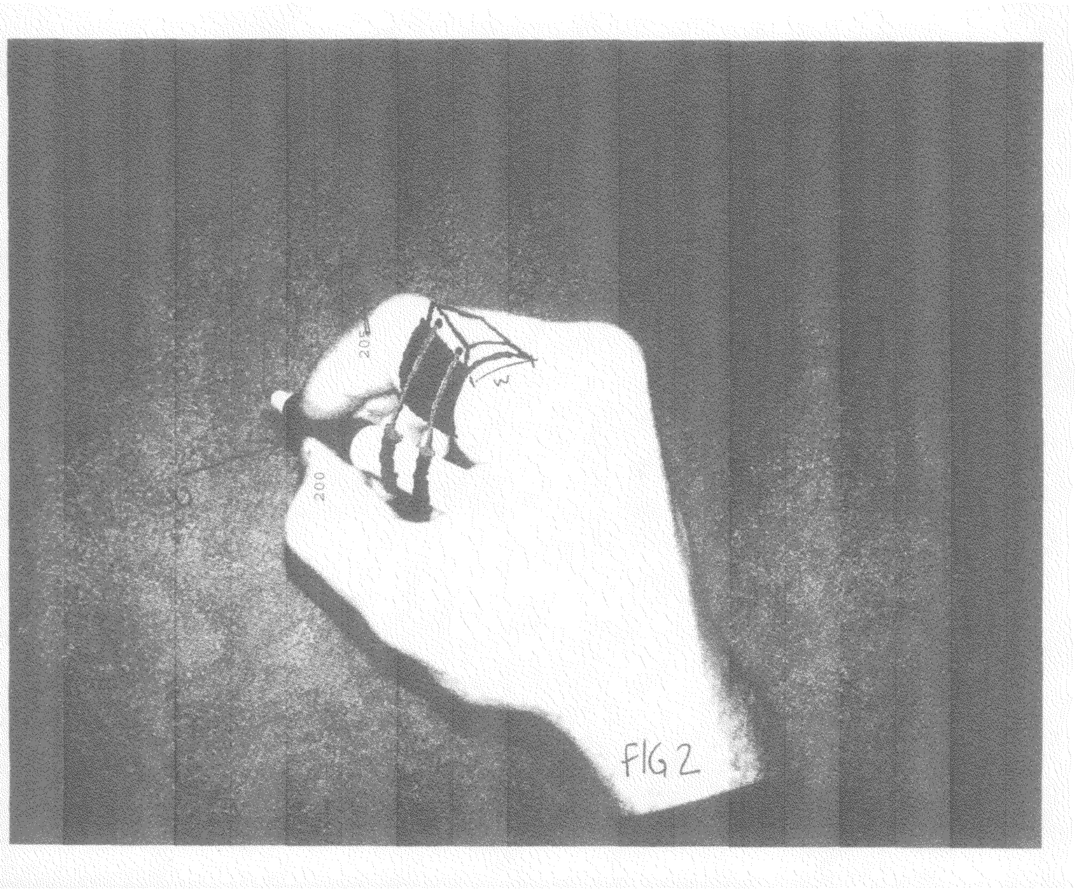

The docked interchangeable tool clip 100 shows a long, flat edge where the strings 104 are permanently fixed 103. Also shown on this edge are two end magnets 101, and one middle magnet 102. The two end magnets 101 are permanently attached and flush to the flat edge featuring the same polarity as one another. The middle magnet 102 is also permanently attached and flush to the flat edge but features a polarity that is the reverse of the two end magnets 101. The polarities of the end magnets 101 and the middle magnet 102 are parallel to counterparts on the front edge of the housing 106. This is best shown in FIG. 2. The end magnets on the housing 200 attract the end magnets on the edge of the tool clip 101, and the middle magnet on the housing 201 attracts the middle magnet on edge of the clip 102. As stated the polarities of the end magnets 200 & 101 are reverse of the middle magnets 201 & 102, and thus the end magnets 200 & 101 repel the middle magnets 201 & 102. When this attraction and repulsion is paired with the retraction force applied on multiple strings 104, the result is a predictable resting or non-use position for an attached tool that is held stable if and when the mount moves around as it would if mounted on a user's finger.

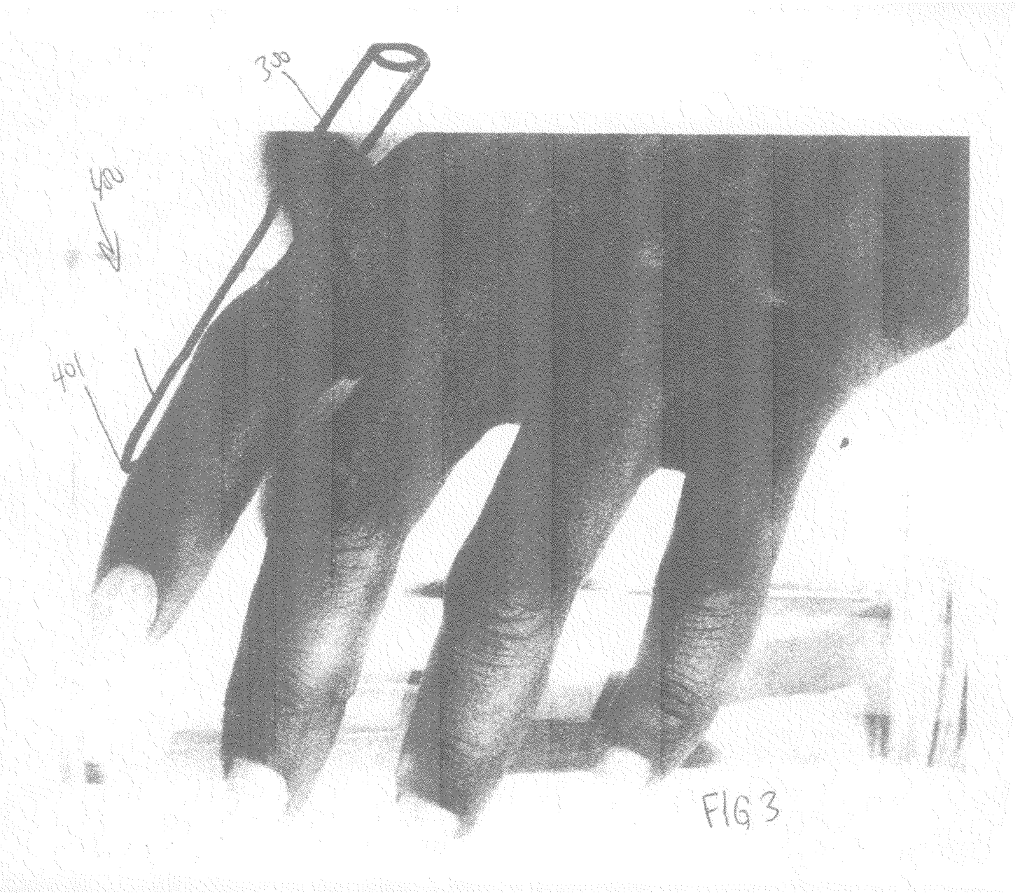

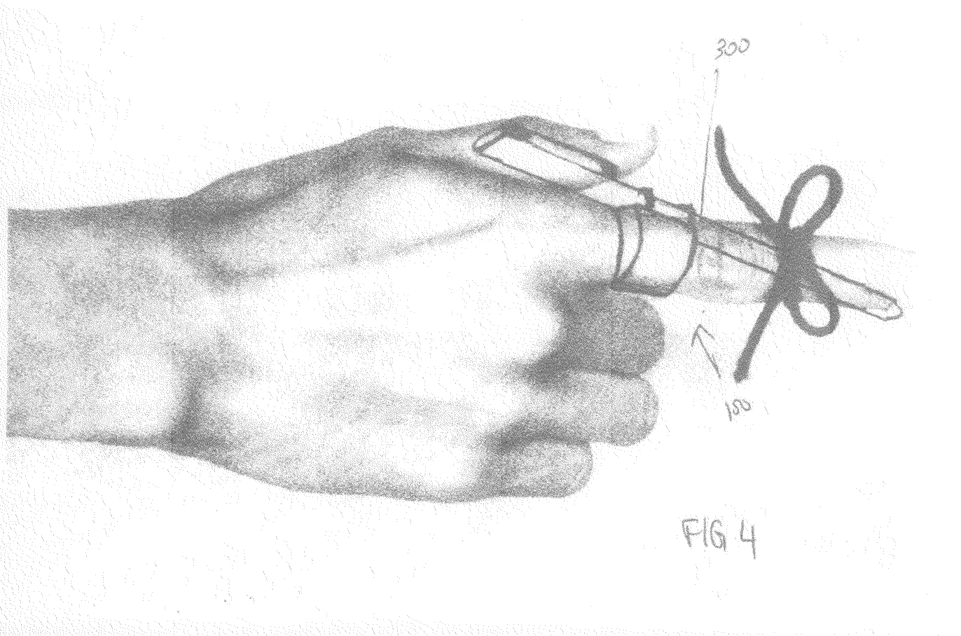

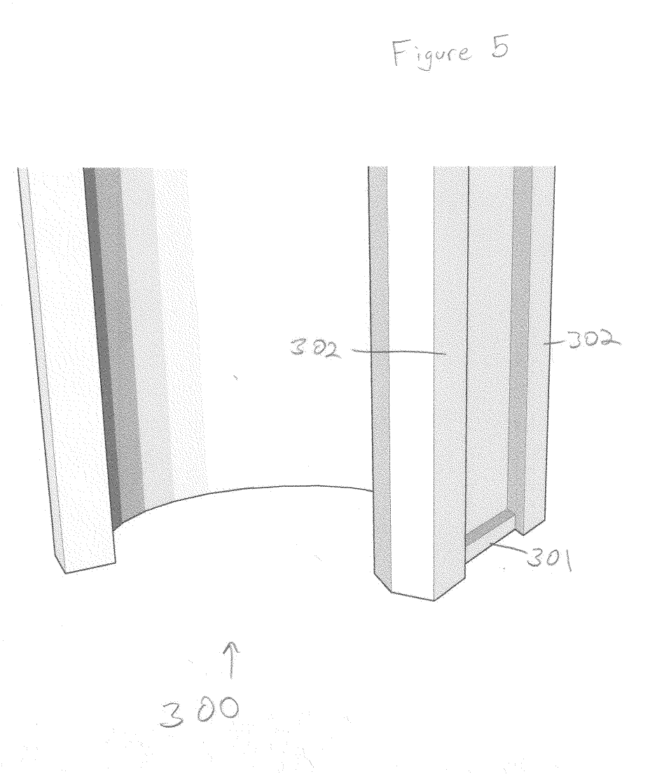

The docked interchangeable tool clip 100 in both FIG. 1 and FIG. 2 is comprised of two parts, which are shown separated for the reader in FIG. 3. The two parts are the female tool clip 300, and the male retraction mechanism attachment 306. These components dock together either via a male-female sliding action as shown or via another docking mechanism such as buttons, clips, etc. featured in the art. In the preferred embodiment shown, the female tool clip 300 features a stopper 301 that halts the sliding of the male retraction mechanism attachment 306 once it is fully docked. This stopper is illustrated most clearly in FIG. 5. The retraction mechanism attachment 306 features a notch 304 to accommodate the stopper 301 such that when fully docked the two share a single edge. Also featured by the tool clip 300 is an off-setting of one of the female lips 302, which leaves a space 303 that allows for quick alignment of the male and female parts to facilitate quick and easy docking. Both the notch 304 and the space 303 are illustrated most clearly in FIG. 4. The sliding mechanism illustrated in this preferred embodiment is such that it allows the attached tool to be used without fear of it becoming unattached from the retraction mechanism during use. It also allows the user to keep one clip 300 attached to one tool and another clip 300 possibly of another size and/or shape attached to another tool for easy exchanging between the two tools on the same device in the same ideal location.

Because the sliding interchange allows such great flexibility for the user it is also the preferred embodiment for another interchange on the present tool holding device. The remaining FIGS. 6-12, are illustrations of a preferred embodiment of the sliding docking mechanism applied to a separated housing 800 and mounting devices such as a ring 801 and a flexible band 902.

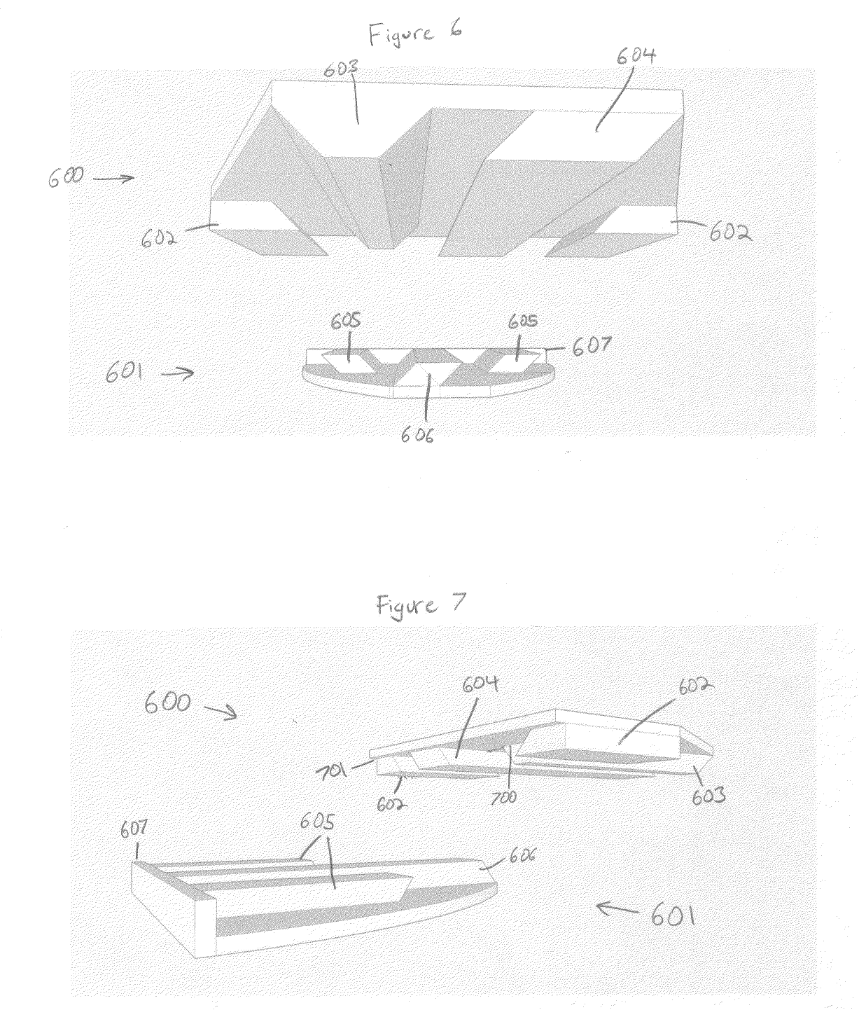

Illustrated in FIG. 6 are the female half of the sliding docking mechanism 600 and the male half of said docking mechanism 601. This preferable embodiment possesses two shorter lips on the male half 605 and on the female half 602 that provide side-to-side stability. It also possesses one long female lip 604 and one long male lip 606 in the middle of the male 601 and female 600 halves to provide front-to-back stability. FIG. 7 shows an open-space feature 700 similar to the space 303 on the above mentioned tool clip docking mechanism in that it allows the user a quick reference of how the male and female components line up to slide together. FIG. 7 also illustrates a stopper 607 on the male half 601 and an overhang 701 on the female half 600.

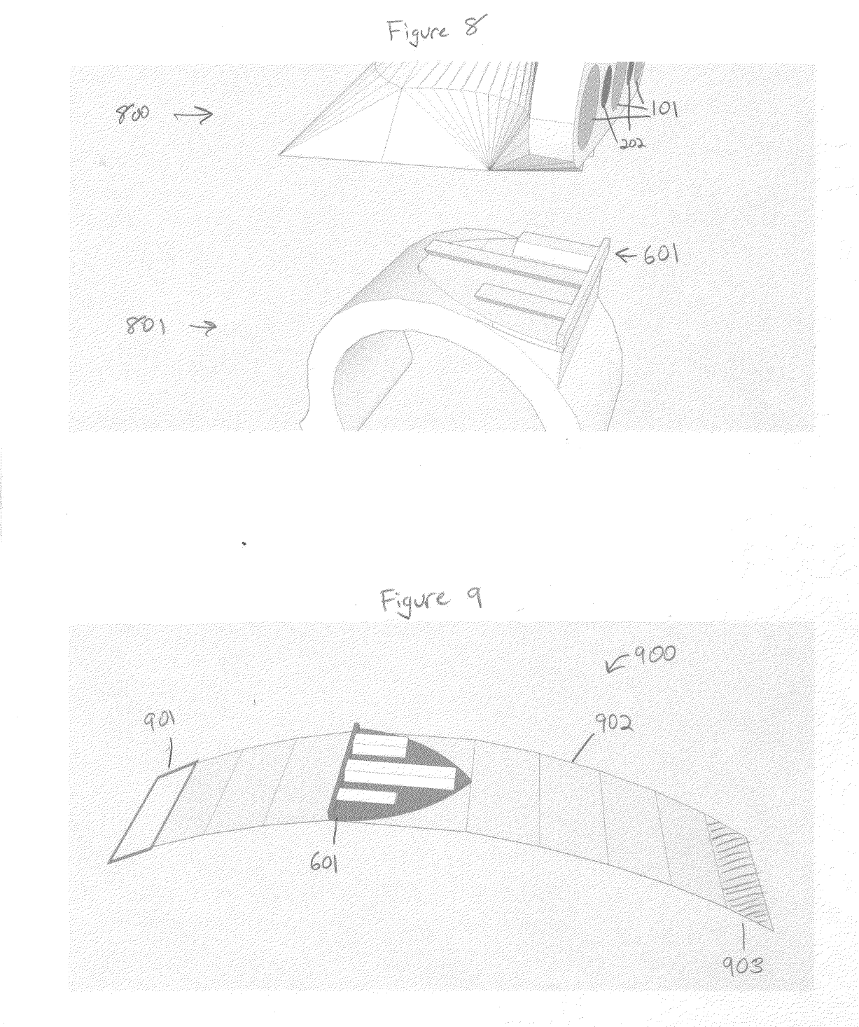

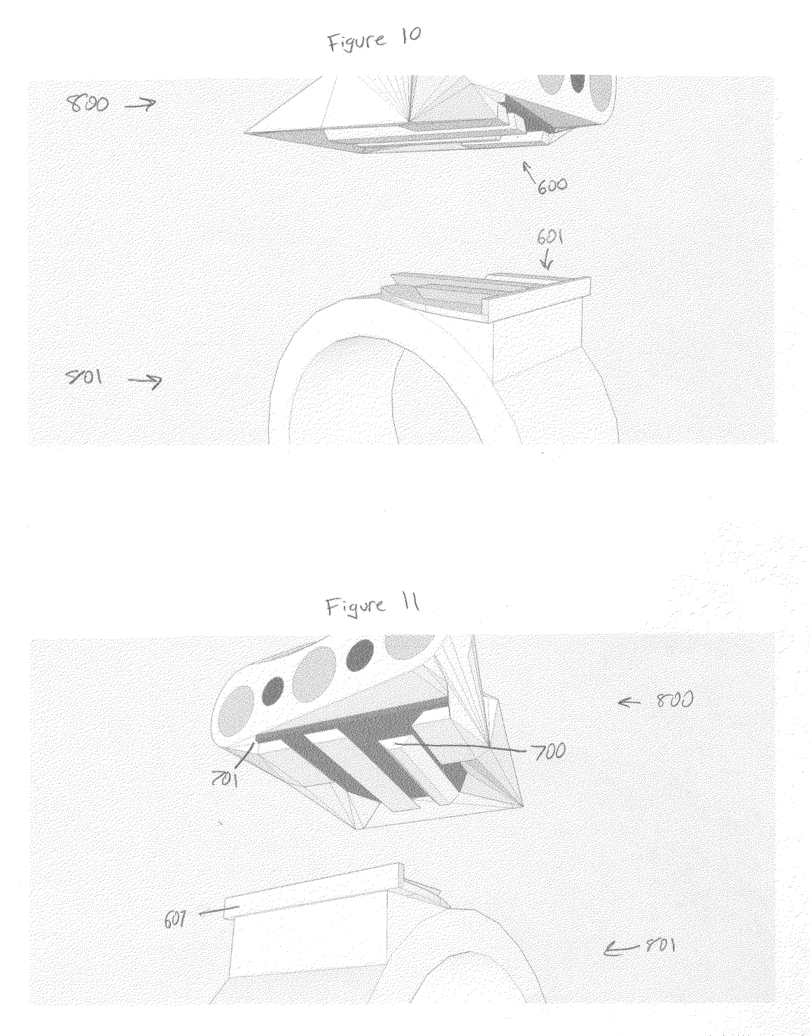

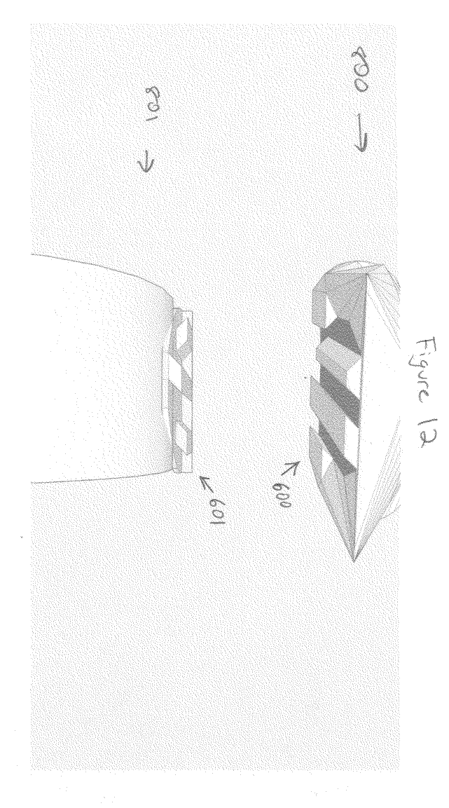

A preferred incorporation of the slide-docking mechanism into the present invention is featured in the following figures: FIG. 8, FIG. 10, FIG. 11, & FIG. 12. In these figures, the male half of the sliding mechanism 601 is fixed to a ring 801 in a configuration that would look very similar to that illustrated in FIG. 1 when fully assembled. Shown in FIG. 10, FIG. 11, & FIG. 12 is the corresponding female half of the docking mechanism 600 incorporated into a separated housing for the retraction mechanism 800. FIG. 11 most clearly shows the open-space feature 700, overhang feature 701, and the stopper feature 607. Working together, these three features provide a quick and error-free exchange of housing units 800 and mounting devices 801 & 900. FIG. 9 illustrates an alternate preferable deployment of the docking mechanism onto a flexible band 902. In this preferred configuration, the male half of the docking mechanism 601 is permanently attached to a flexible band featuring a loop 901 for the band to pass through and double-back on itself to allow a fastener 903, such as hooks or Velcro, to attach to another place on the band. This preferred configuration is more flexible than the ring configuration 801, allowing it to be mounted in more places according to the user's needs. Though only illustrated attached to a ring 801 and a flexible band 902, the present invention is not limited to only those mounting devices, nor to mounting devices in general except that the inclusion of a docking mechanism such as the slide-docking mechanism of FIG. 6 and FIG. 7 is a necessity of it and thus mounting of some kind is also required. The present invention is also not limited to the slide-docking mechanism as the only means of docking its interchangeable parts.

An alternate preferred docking style that is not illustrated will now be described. This docking mechanism will consist of a male and female half. Each half will feature either male or female ordinary small snaps configured in an equilateral triangle or square. An advantage of the snap-docking mechanism over the slide-docking mechanism is that the user can change the angle of the separated housing 800 simply by undocking it, turning it, and re-docking it. Though the present writing mentions only two docking styles it is not limited to only those styles, however any docking mechanism used must allow for rigid placement such that the tool attached to the device will always retract to a given position and orientation.

While preferred embodiments of the present invention have been described with regard to multiple embodiments, it is recognized that additional variations of said invention may be devised without departing from the innovative conception thereof.

1: A method of holding a tool such that it is always conveniently placed when needed for use, able to be used easily, and also out of the way when not in use. This method consists of a three-part tool holder capable of temporarily attaching to a tool and automatically storing it in a fixed orientation and in a place that is out-of-the-way of the user's present task, while keeping that tool ideally convenient for when needed.

2: A method in which one part of the three-part tool holder of the above claim is a detachable housing unit containing a retraction mechanism, which applies force while allowing an attached tool to be moved from a non-use to a use position and back again as needed.

3: A method in which the three-part tool holder of the above claims assembles in a way that it can be temporarily attached to either the user's index finger, as featured herein, to other or multiple fingers, or to another place the user finds convenient. Though a ring is featured as the preferred attachment-style to the user's finger, other types of attachment devices such as bands or clips could also be utilized. It is also recognized that the present invention is not limited to attachment devices such as those listed and could dock directly to any object that possessed a corresponding docking mechanism.

4: A method in which the retraction mechanism of the above claims provides force sufficient for an attached tool to retract from the use position to the fixed orientation of the resting or non-use position without assistance. Though elastic strings are featured as the preferred mechanism for supplying this retraction force, the present invention is understood to not be limited to this mechanism of retraction and could feature a coiled spring or other retraction mechanism featured in the art.

5: A method in which the retraction mechanism of the above claims features an attachment that is permanently tethered to it via at least two strings or cords that facilitate the extension and retraction.

6: A method in which the housing unit of the above claims and retraction mechanism attachment of the above claims come together predictably in a fixed orientation via retraction force on the strings of the above claims in combination with an alignment-maintaining mechanism. Said alignment-maintaining mechanism could consist of a series of magnets polled in reverse of one another, as featured, via the addition of more strings or cords, or via a male and female component. The purpose of said alignment-maintaining mechanism is to allow only one configuration for said attachment and thus for the attached tool while in a non-use position. A further aspect of said alignment-maintaining mechanism is that though featured herein is a three magnet series with the middle reversed in polarity from those on the edges, the present invention is not limited to that number of magnets, nor is it limited to magnets, a number of strings or cords, a male and female component, or a combination therein as the aligning mechanism.

7: A method in which the attachment to the retraction mechanism of the above claims is either in itself an apparatus capable of temporarily attaching to differently-sized tools, or, as featured herein, features half of a docking mechanism, the corresponding other half being a feature of many variably-sized apparatuses capable of temporarily attaching to tools of varying sizes.

8: A method in which an apparatus, or the apparatuses, from of the above claims that attach temporarily to a tool and dock with the retraction mechanism attachment of the above claims. Said apparatuses are capable of attaching variable-sized tools to the device, either via interchanging one apparatus for one of another size via docking, such as featured herein, or via another method such as, but not limited to, adjustable sizing of the apparatus, Velcro, friction mounting, or temporary adhesive. Though a slide-style docking mechanism with multiple differently-sized apparatuses is featured herein as the preferred embodiment of this feature, the present invention is understood to not be limited to this attachment style and could feature buttons, snaps, or another style of temporary attachment.

9: A method in which the retraction mechanism of the above claims and/or the detachable housing unit from of the above claims can feature a locking mechanism that either engages automatically, similarly to an automatic tape measure, or that the user can choose to engage through the manipulation of the string (similar to every-day blinds), a button, or a lever. When engaged, said locking mechanism clamps the strings or cords of the above claims resisting the retraction force from the retraction mechanism of the above claims until the user disengages the locking mechanism.

10: A method in which the attachment device of the above claims provides counter-rotational force for the retraction mechanism via friction or, as featured, via a slight lip where the user can apply said counter-rotational force conveniently.

11: A method in which the detachable housing unit of the above claims features half of a docking mechanism, the counterpart of which is preferably located on the fastening device of the above claims. This docking mechanism allows varying fastening devices to attach to varying housing units such that various housing units configured specifically to accommodate various tools can be attached to any of those fastening devices, or on any object featuring the corresponding docking mechanism. Said docking mechanism slides, clips, or snaps into place such that it is sturdily in place but can also be easily removed if so desired by the user.
